(19) United States
(12) Patent Application Publication
(10) Pub. No.: US 2015/0356253 A1
(43) Pub. Date: Dec. 10, 2015

(54) MEDICAL INFORMATION SYSTEM WITH AUTOMATIC RECONFIGURATION AND DATA BINDING

(71) Applicant: The General Hospital Corporation, Boston, MA (US)

(72) Inventors: Nathaniel M. Sims, Milton, MA (US); Michael Dempsey, Groton, MA (US); Kimberly Donovan, Milton, MA (US)

(21) Appl. No.: 14/820,769

(22) Filed: Aug. 7, 2015

Related U.S. Application Data
(63) Continuation of application No. 12/682,489, filed on Sep. 13, 2010.
(60) Provisional application No. 60/979,756, filed on Oct. 12, 2007.

(51) Int. Cl. G06F 19/00

(52) U.S. Cl. CPC G06F 19/322; G06F 19/321

(57) ABSTRACT

Disclosed herein are methods, apparatus and computer program products for a customizable and contextually relevant medical system with automatic reconfiguration and data binding. Some embodiments relate to an enterprise digital assistant capable of changing its functionality based on context and binding medical information associated with one medical entity, for example, a care giver, patient or medical system/device, to medical information associated with another medical entity. Other embodiments relate to a method for automatically reconfiguring an enterprise digital assistant based on context and performing contextually relevant data binding. In this regard, the method provides a module for processing medical data from a plurality of medical entities and transmitting the data to one or more clinical information systems.

### TECHNICAL FIELD

This description relates to a medical information system.

### BACKGROUND

As technology becomes more ubiquitous and fewer caregivers must attend to more patients in, for example, acute care, ambulatory, or home care settings, the need to provide clinicians with flexible, easy-to-use technology becomes paramount. The various known medical devices, systems, and solutions, e.g., diagnostic tools, monitors and information systems, are highly specialized, i.e., they typically do one thing very well. For example, a typical commercial Electronic Medical Record (EMR) may have hundreds of modules. In such a medical system, each module serves a specific medical need, such as, for example, a need for flow sheets or a need for information on pediatric patients.

Accordingly, there is a need to create a system that allows various medical devices, systems and solutions to be easily configured, connected, and used by both highly-trained and less-trained clinical workers. In many situations, this need is further complicated by the fact that there are thousands of legacy medical systems in any given hospital. In addition, the medical systems may have little or no standard connectivity. Consequently, communication between the various medical devices and systems are poor. For this reason, many hospitals are seeking connectivity solutions that can connect virtually any medical device or system from any vendor, to any clinical system without locking the hospital to a single vendor or medical system.

### DESCRIPTION OF THE DRAWINGS

These embodiments and other aspects of this invention will be readily apparent from the detailed description below and the appended drawings, which are meant to illustrate and not to limit the invention.

FIG. 1 is a high-level schematic diagram of an exemplary workflow aware connectivity (WAC) system.

FIG. 2 is a schematic diagram of an exemplary enterprise digital assistant architecture.

FIG. 3 illustrates an exemplary WAC client architecture implemented by an enterprise digital assistant.

FIG. 4 is a schematic diagram of an exemplary WAC server architecture.

FIG. 5 is a flowchart depicting an exemplary method for automatically reconfiguring an enterprise digital assistant based on context.

The present invention will be more completely understood through the following detailed description, which should be read in conjunction with the attached drawings. In this description, like numbers refer to similar elements within various embodiments of the present invention.

### DETAILED DESCRIPTION

Disclosed herein are methods, apparatus and computer program products for a customizable and contextually relevant medical system with automatic reconfiguration and data binding. Some embodiments relate to an enterprise digital assistant capable of changing its functionality based on context and binding, e.g., associating, linking and/or combining, medical information associated with one medical entity, for example, a care giver, patient, to medical information associated with another medical entity, for example, a medical device or system.

Other embodiments relate to a method for automatically reconfiguring an enterprise digital assistant based on context and performing contextually relevant data binding. In this regard, the method provides a module for processing medical data from a plurality of medical entities and transmitting the data to one or more clinical information systems.

### Workflow Aware Connectivity (WAC) Architecture:

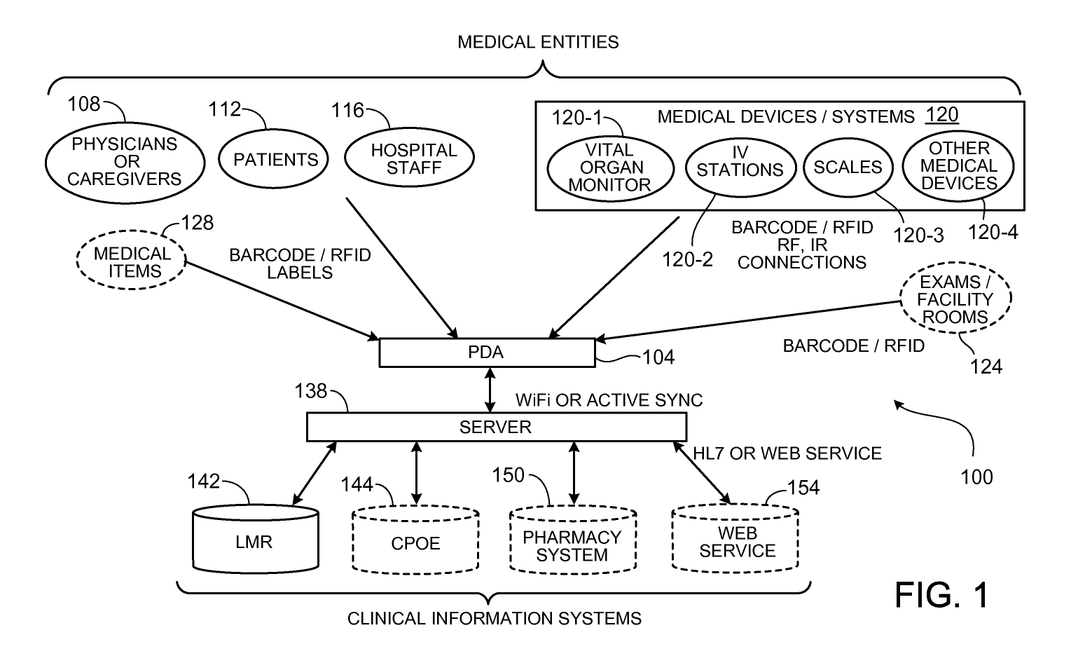

FIG. 1 is a high-level schematic diagram of an exemplary workflow aware connectivity (WAC) system 100 that includes an enterprise digital assistant (EDA) 104. As shown, the WAC system 100 includes one or more medical entities 108-124, all of which communicate with, e.g., transmit data to and/or receive data, from the enterprise digital assistant 104, a WAC server 138 in data communication with the enterprise digital assistant 104, and one or more clinical information systems 142-154 in data communication with the WAC server 138. In some embodiments, the enterprise digital assistant 104 is also configured to scan, or “read” unique machine-readable identifiers, e.g., barcodes, RFID tags.

In some embodiments, the WAC system 100 is implemented as a general computer network system including a plurality of network devices, routers, I/O components, stand-alone computer systems, and servers running contextually relevant applications. Examples of contextually relevant applications include service modules that implement user logging, process flow control, and/or guidance modules. Although only one enterprise digital assistant 104 is shown in FIG. 1, more than one enterprise digital assistants (generally 104) are typically used in the WAC system 100.

The medical entities 108-124 in a WAC system 100 include, for example, caregivers or physicians 108, patients 112, and health care employees and/or hospital staff 116. The medical entities 108-124 also include medical devices and/or systems 120, such as, for example, vital sign monitors 120-1, e.g., blood pressure, body temperature, pulse or heart rate and respiratory monitors, IV stations 120-2, e.g., IV pumps, weighing and/or height measuring scales 120-3, in a physical examination room, and other medical devices or systems 120-4. In some embodiments, the medical devices and/or systems 120 are classified as being either medical actuators, i.e., mechanical or electronic medical devices or systems configured to control physiological parameters, or activity in other medical systems, or medical sensors, i.e., mechanical or electronic devices or systems configured to detect physiological parameters, or activity in other medical systems. An example of a medical actuator is a drug infusion pump and an example of a medical sensor is a cardiac monitor.

In some examples, the other medical devices or systems 120-4 include, for example, printers, copiers, and/or communication devices, e.g., telephones and fax machines. In one example, the other medical devices or systems 120-4 include a drug label printer. One example of a drug label printer is described in a provisional application identified by attorney docket 00786-829P01 entitled “Labeling,” naming as inventors Harry Manalopoulous, Wilton Levine, Nat Sims, Mike Dempsey and Kim Donovan, and filed of even date herewith, the contents of which are herein incorporated by reference. In certain embodiments, the other medical devices or systems 120-4 also include legacy medical devices or systems having limited compatibility with more advanced communication interfaces.

For example, a legacy medical device such as a CAS 740 monitor, is used to capture a patient's 112 vital signs, e.g., ECG, heart rate and/or blood pressure. The CAS 740 monitor has no standard network connectivity. However, the CAS 740 has a legacy RS-232 port. Accordingly, the CAS 740 can be configured to communicate, i.e., transmit and/or receive in a direct, point-to-point fashion, within the WAC system 100 using an RS-232 to Bluetooth converter.

In some examples, the medical entities 108-124 include examination or hospital facility rooms 124. In other examples, the medical entities 108-124 also include medical items 128, e.g., repackaged pills/tablets, drug bottles, drug labels and/or patient medical history charts.

The medical entities 108-124 in the WAC system 100 are each identified by the enterprise digital assistant 104 through a unique identifier, such as, for example, a bar code, a 2-D bar code or other symbol, or an RFID tag. As a result, two identical blood pressure monitors in a health care ward, for example, would be identified uniquely even though they were manufactured or are currently being serviced by a single vendor.

In another example, the enterprise digital assistant 104 can be configured to scan a barcode on a door jamb of a facility room, e.g., a physician's office and/or a patient examining room. As a result, the location of the transaction, e.g., the physician's office or the patient examining room, is also bound to the medical transactional information. In this manner, in some situations, a health care facility is able to track, review and optimize the use of facility rooms. In yet another example, the health care facility is also able to similarly track, review and optimize the use of other facility assets, e.g., the medical devices or systems 120, in a manner similar to that of the facility rooms, as described above.

In some examples, a standard identification system, such as the standards prescribed in “Positive Identification for Patient Medication Safety, Specification Version 1.0” Published Oct. 5, 2007, made available by the Health Industry Business Communications Council (HIBCC) (hereafter referred to as “the Standard”), is used to implement the unique identification scheme.

The Standard accommodates a data set rich enough to implement a medication administration record system even in the absence of a computer network. As a result, the Standard's specification enumerates both a small number of required data elements (more appropriate to a connected environment), as well as a large number of optional data elements that support more robust functionality in a non-connected, standalone, environment. Accordingly, the Standard also provides a dictionary of the mandatory and optional data elements for each area of use and also describes how this information is to be organized.

As described in further detail below, the enterprise digital assistant 104 is a computational device having one or more software modules for automatic reconfiguration. In some embodiments, the enterprise digital assistant 104 is implemented as a portable electronic device or a handheld device, such as, for example, the Symbol MC-70 manufactured by Motorola, Inc., Schaumburg, Ill. In another example, the enterprise digital assistant 104 is implemented as a computing station, such as a personal computer or a workstation. In yet another example, the enterprise digital assistant 104 is implemented within a mobile telephone.

The enterprise digital assistant 104 is configured to scan a unique identifier on a medical entity 108-132, e.g., an identifying machine-readable tag associated with a patient, and implement a communications protocol based on the unique identifier for processing medical data related to the medical entity 108-132, e.g., patient medical history information. Accordingly, in response to the unique identifier, the enterprise digital assistant 104 automatically reconfigures to a contextually relevant mode for managing medical information.

The enterprise digital assistant 104 uses, for example, wired connections, e.g., via an RS-232 or universal serial bus (USB), and/or wireless connections, e.g., via radio frequency (RF), BlueTooth or infra-red (IR) connections, to establish a communication channel with a selected one of the medical entities 108-128. In some embodiments, using this channel, the enterprise digital assistant 104 identifies the type of medical entity 108-128 with which it is in communication. The enterprise digital assistant 104 then uses this information to select an appropriate communication channel or link and a protocol for receiving and transmitting medical information from the selected medical entity 108-128.

In certain embodiments, in order to eliminate cross-communication errors, the enterprise digital assistant 104 is configured to scan a unique identifier on a medical device or system 120 of a, for example, plurality of medical devices or systems 120, and communicate with only that particular medical device or system 120 in a current context. For example, a 2-D barcode on a medical device or system 120 can include a pointer to a uniquely addressable Bluetooth radio device that is associated with the medical device or system 120. An example of such a barcode identification system is described in the Standard.

In addition, the IEEE 802.15.1-2002 Wireless Personal Area Network standard, of which Bluetooth is a widely implemented variant, describes such a uniquely addressable Bluetooth radio device. In other embodiments, the 2-D barcodes would not include a pointer to a uniquely addressable communication link or module. For example, typically IRDA data communication modules do not need to be uniquely addressed since a user can directly point the enterprise digital assistant 104 to an IR port to establish a communication channel.

In other embodiments, the enterprise digital assistant 104 is configured to communicate simultaneously with a predetermined number of medical devices and/or systems 120 in the same context. For example, the enterprise digital assistant 104 can be configured to scan a barcode on a pulse oximeter, and automatically open a communication channel with both the pulse oximeter and a coagulation tester to simultaneously retrieve blood clotting time information and SpO₂ levels information corresponding to oxygen levels in blood.

In yet other embodiments, the enterprise digital assistant 104 is configured to scan unique identifiers on one or more medical entities 108-124 to determine a context for managing medical information. For example, the enterprise digital assistant 104 can be configured to scan barcodes on labels affixed to drug bottles in an operating room to reconfigure to an anesthetic syringe label printing contextual mode.

The enterprise digital assistant 104, further establishes a communications channel with a record server, e.g., the WAC server 138 through, for example, wireless, e.g., WiFi and/or Bluetooth, or wired, e.g., Ethernet, Active Sync, connections. In some examples, the enterprise digital assistant 104 is used in an austere environment, i.e., in the absence of any network or server connection, such as, for example, in a battlefield station or an emergency medical vehicle, e.g., an ambulance. In such situations it is useful to support an identification system having robust functionality in a non-connected environment, such as the identification system described in the Standard.

The enterprise digital assistant 104 is also configured to parse, i.e., intelligently scan or “read,” a 2-D barcode to determine which information is critical. For example, a 2-D barcode on a medical container can include information about drug concentration, and possibly other information such as, for example, a patient's 112 name and expiration date of the drug. The enterprise digital assistant 104 accordingly parses the barcode to determine relevant information for a given context.

In some embodiments, the enterprise digital assistant 104 is also used to upload a macro, e.g., a subroutine including instructions, to a medical device or system 120, e.g., a drug infusion pump. For example, the enterprise digital assistant 104, after determining a context, can automatically upload, for example, drug administering instructions to the drug infusion pump.

The WAC server 138 is implemented by a network server, such as, for example, a standard single processor server, e.g., a server running Microsoft Windows Server. In one example, software such as Internet Information Services (IIS) from Microsoft Corporation is used to provide network services. Generally, the modules implementing a WAC routine, as described in further detail below, are written in any standard programming language, e.g., C#, C/C++, or JAVA.

The WAC server 138 is in further network communication with one or more clinical information systems 142-152. The clinical information systems 142-152 include, for example, longitudinal medical record (LMR) systems 142, computer provider order entry (CPOE) systems 146 and/or pharmacy systems 150.

The clinical information systems 142-152 typically store patients' medical history, data and information. In some embodiments, a patient's 112 medical insurance coverage information, such as, for example, insurance codes for indicating if a medical transaction, e.g., a medical procedure and/or a medical test, is eligible for payment, co-payment or is not eligible for payment, is also bound to the medical information collected and stored in the clinical information systems 142-152.

In some embodiments, the medical transaction would include each step performed in a workflow associated with the medical procedure and/or the medical test. Accordingly, a local billing system (not shown) can provide itemized bills detailing each medical transaction and include insurance information, e.g. information based on insurance codes corresponding to each medical transaction. Alternatively, requests for payments can be transmitted electronically to the insurance carrier.

In one example, an insurance carrier can require compliance with a certain procedure, e.g., a procedure requiring the use of carrier-specific insurance codes corresponding to each medical transaction that is recorded. In such a situation, the billing system automatically determines the insurance carrier providing coverage to a patient 112 based on the patient's 112 medical information. In this manner, the patient's 112 insurance information is automatically bound to his medical record.

In some examples, the WAC server 138 also connects to other Webservice Servers 154 in order to publish or subscribe to other information or services. Persons having ordinary skill in the art will readily recognize that the WAC system 100 described herein can be expanded to include medical entities 108-124 and/or clinical information systems 142-152 other than those described herein using the techniques and methods described herein.

### WAC Enterprise Digital Assistant Architecture:

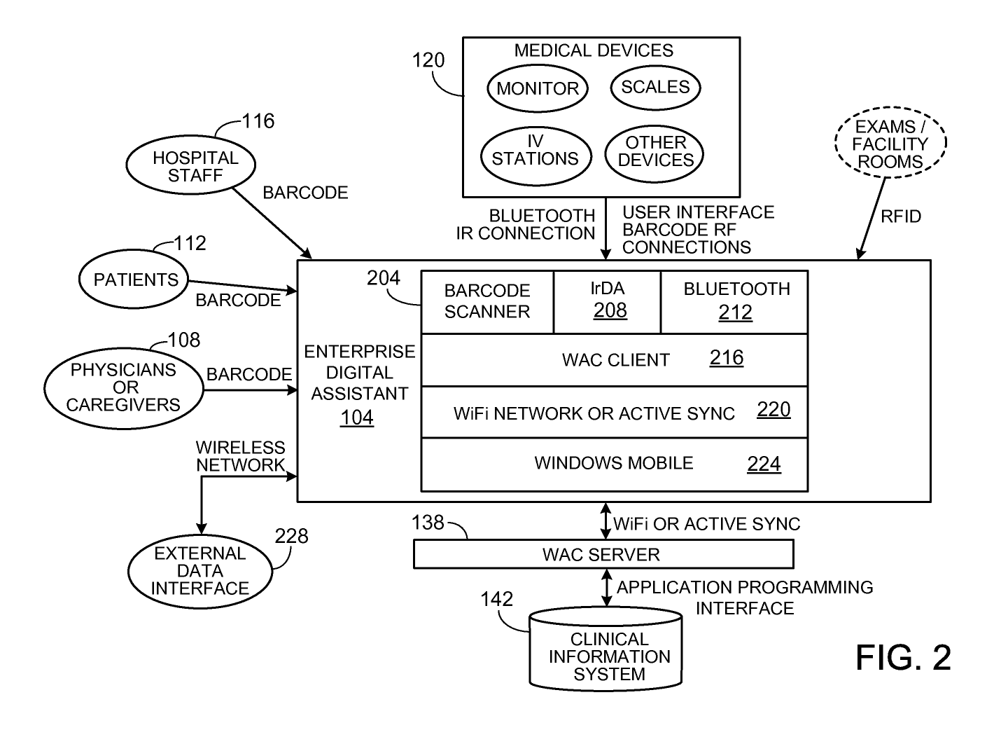

FIG. 2 is a high-level schematic diagram illustrating an exemplary enterprise digital assistant 104 for use in the WAC system 100. As shown, the medical entities 108-124 interface with the enterprise digital assistant 104 in a variety of ways. For example, in some healthcare wards, the care givers 108, patients 112, and hospital staff or employees 116 are each assigned identifying tags, e.g., wristbands or identification badges, that include unique machine-readable identifiers, e.g., barcodes or radio frequency identification (RFID) tags. Accordingly, the enterprise digital assistant 104 scans the unique identifiers to establish a context for managing medical information.

The medical devices and/or systems 120 in the WAC system 100, each communicate with the enterprise digital assistant 104 over a communications channel established by, for example, Bluetooth or infra-red (IR), as described above. The enterprise digital assistant 104 includes scanning and communications modules, such as, for example, a barcode scanner 204, an IR device 208 for establishing an infra-red communications channel with a medical device and a BlueTooth device 212 for establishing a BlueTooth communications channel with a medical device. In some examples, the barcode scanner 204, IR device 208, and/or the BlueTooth module 212 are implemented independent from and in data communication with the enterprise digital assistant 104.

The enterprise digital assistant 104 further includes a WAC client 216 and a network manager module 220, such as, for example, a WiFi Network module or an ActiveSync module. In some embodiments, the enterprise digital assistant 104 is implemented as a portable electronic device running a mobile operating system 224, e.g., Windows Mobile from Microsoft Corporation. In other embodiments, the various modules in the enterprise digital assistant 104 are implemented either in software or hardware with associated software. In yet other embodiments, the enterprise digital assistant 104 further communicates with an external data interface 228 over a wireless network.

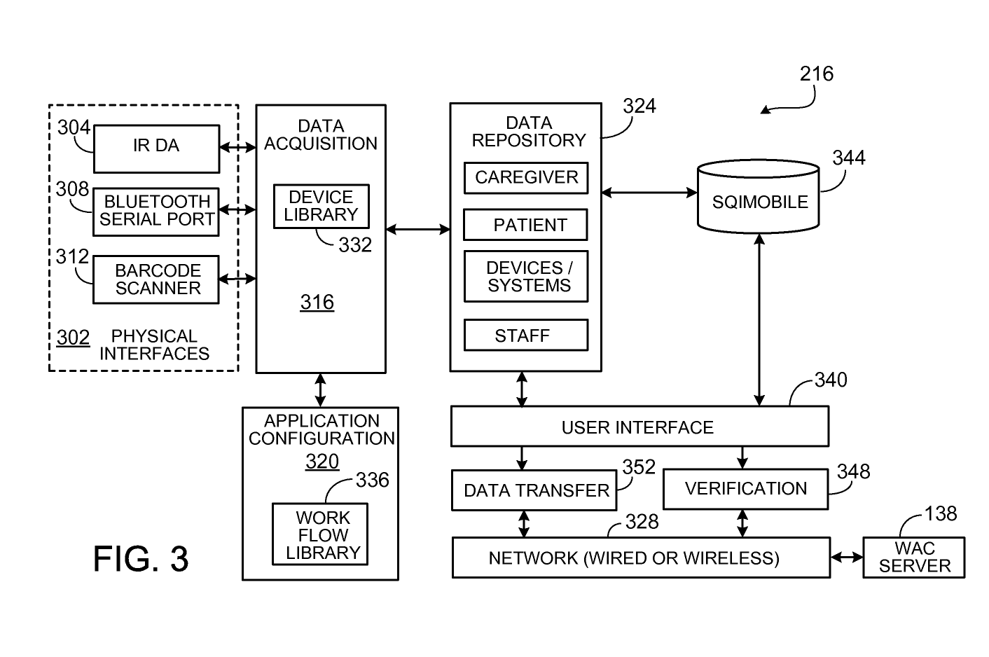

FIG. 3 is a schematic diagram of an exemplary WAC client 216 of the enterprise digital assistant 104 for identifying and communication with a variety of medical devices and/or systems 120 in the WAC system 100 (FIG. 1). The WAC client 216 provides communication with the medical devices and/or systems 120 through a physical interface 302. Examples of a physical interface 302 include an infra-red data association (IRDA) port 304, a Bluetooth serial port 308, and/or a data retrieval system established by a barcode scanner 312. In some embodiments, the physical interface 302 also includes wired systems, e.g., RS-232 and/or Ethernet wireless systems.

As shown, the WAC client 216 further includes a data acquisition module 316 and an application configuration module 320. The data acquisition module 316 is in communication with a data repository module 324. In addition, the application configuration module 320 is in communication with the WAC server 138 through a network interface module 328.

A physical interface 302 receives identifying information from an external medical device or system 120. Subsequently, the physical interface 302 transmits the identifying information to the data acquisition module 316. The data acquisition module 316 includes a device library 332 that contains a collection of data protocols. The data protocols provide to the data acquisition module 316 a communication protocol for each of the medical devices and/or systems 120.

For example, in one hypothetical scenario, the data acquisition module 316 recognizes a drug label printer as, for example, a Zebra model, TLP3842 printer from Zebra Technologies Corporation, Vernon Hills, Ill., based on information contained in a barcode on the printer. Accordingly, the data acquisition module 316 looks up the device library 332 for an appropriate communications protocol. If the appropriate protocol for the printer is, for example, a Bluetooth communications protocol, then the data acquisition module 316 prepares to communicate with the printer through the Bluetooth serial port 308.

Upon identifying a new device, i.e., a medical device and/or system 120 that lacks a corresponding entry in the device library 332, the data acquisition module 316 forwards the identifying information to the application configuration module 324. The application configuration module 324, in turn, establishes a communications channel through the network interface module 328 to connect to the WAC server 138. In this manner, the WAC client 216 downloads an appropriate library entry and communications protocol for the new device and adds the library entry to the device library 332.

In some examples, the new library entry and communications protocol replaces an old library entry and communications protocol in the device library 332. In other examples, the library entry and communications protocol are stored in a temporary cache memory (not shown), for use while the WAC client 216 communicates with the new device. When no longer needed, the library entry and communications protocol are removed from the cache memory.

Once a communications channel with a medical device or system 120 has been established, the WAC client 216 receives and transmits medical information from the medical device or system 120. The data acquisition module 316 then transmits the identifying information and medical information from the medical device or system 120 to the data repository module 324. In some examples, the data acquisition module 316 also transmits the medical information to the application configuration module 320.

The application configuration module 320 reconfigures the enterprise digital assistant 104 to be in a contextually relevant mode based on a collection of workflow protocols stored in a workflow library 336. For example, if the data acquisition module 316 identifies the medical device or system 120 to be a Zebra model TLP3842 drug label printer, the application configuration module 320 determines that a current functionality of the enterprise digital assistant 104 is to print labels for anesthetic drugs. Accordingly, the WAC client 216 loads the appropriate modules and services necessary to perform the current function.

In some examples, the workflow protocols stored in the workflow library 336 are user generated and stored in a memory unit in the enterprise digital assistant 104. In other examples, the workflow library 336 is implemented as a temporary cache (not shown). Accordingly, a complete library of workflow protocols is stored in the WAC server 138. In such situations, an appropriate workflow protocol is downloaded to the temporary cache from the WAC server 138 in a manner similar to that in which communications protocols are downloaded to a temporary cache, as described above.

Upon selecting the appropriate workflow protocol, the application configuration module 320 automatically reconfigures the enterprise digital assistant 104 by communicating the desired functionality and/or operational configuration information to the other modules, e.g., to the data acquisition module 216 and to the data repository module 324. In this manner, all the modules in the WAC client 216 are ready to receive and process identifying data and/or medical information related to the current context. This reconfiguration is regarded as being automatic because it requires no user intervention beyond scanning a bar code or RFIG tag.

The data repository module 324 stores additional identifying information related to a medical device or system 120. For example, the data repository module 324 stores information indicating that the “Zebra” model TLP3842 drug label printer only prints in black-and-white or that the printer is loaded with a special, single-purpose label. In other examples, the data repository module 324 stores additional identifying information or program parameters regarding caregivers 108, patients 112 and/or hospital staff 116.

In some examples, the caregiver 108 enters medical information directly into the data repository 324 through a user interface 340. For example, once the data acquisition module 316 identifies a medical device 120 to be a vital signs monitor, and the application configuration module 320 module configures the enterprise digital assistant 104 to expect vital signs from a patient 112, the data repository module 324 receives medical information and/or data, e.g., patient identifying information through the user interface 324. Accordingly, in such situations, the data repository module 324 stores patient specific information.

In one embodiment, the application configuration module 320 controls the user interface 340. For example, the application configuration module 320 directs the user interface 340 to display certain screens and/or buttons to a user of the enterprise digital assistant 104. The user interface 340 and the data repository module 324 communicate with a database 344 implemented by, for example, an SQL Mobile database, to store long term medical and identifying information in that database 344.

In some examples, the user interface 340 also communicates with a verification module 348 that verifies the identity of the caregiver 108 and/or patient 112. For example, in some embodiments, the verification module 348 authenticates a user of the enterprise digital assistant 104 by soliciting entry of a username and password combination through the user interface 340.

In some embodiments, the verification module 348 also validates medical information entered by a user of the enterprise digital assistant 104 to ensure that the medical information is realistic and within expected bounds. In another example in which a caregiver 108 can manually enter a patient's 112 blood pressure reading, or a blood pressure monitor can electronically transmit the reading over a communications channel to the enterprise digital assistant 104, the verification module 348 automatically validates the reading and generates an alert if the reading is incorrect, e.g., too high or too low.

In some embodiments, the verification module 104 automatically validates the medical information to determine if immediate attention is required. Accordingly, the enterprise digital assistant 104 would be configured to prompt the caregiver 108 through a series a screens on the user interface 340, to enter the correct value for the medical information, e.g., the blood pressure reading, in this case.

In certain embodiments, the verification module 104 is also configured to verify critical medical information, e.g., information regarding white blood cell count, pulse rate and/or blood oxygen levels, prior to transmission to the network interface module 328. For example, the verification module 104, through a series of prompts through the user interface 340, alerts the caregiver 108 to verify the critical medical information.

In other embodiments, the verification module 104 is also configured to verify critical dosage information, e.g., dosage information and/or drug concentration levels in, for example, anesthesia syringes during surgery and/or pills, that is administered to a patient 112. In this manner, the verification module 104 provides an error-checking mechanism.

In yet other embodiments, a medical device or system 120 can already include an error checking mechanism. For example, the drug infusion pump described in U.S. Pat. No. 5,681,285, titled “Infusion pump with an electronically loadable drug library and a user interface for loading the library,” incorporated herein in its entirety by reference, verifies critical information, e.g., drug dosage information and/or drug concentration levels against previously established limits set by vendors or new limits set by a caregiver 108. Accordingly, the verification module 104 can be configured to transmit to the drug infusion pump the critical information for verification.

Once the user is authenticated as an authorized caregiver 108 the application configuration module 320 automatically reconfigures the enterprise digital assistant 104 to change functionality and to prepare for further input. In one embodiment, the verification module 348 prompts the user to confirm the identity of the patient before entering vital patient history information.

In other embodiments, the verification module 348 also ensures that vital patient history information that is sent over the network interface module 328 to the WAC server 138 or directly to the clinical information systems 142-152 is “read back” accurately. In certain embodiments, the verification module 348 queries the clinical information systems 142-152 or the WAC server 138 to determine if the information it had sent earlier was accurately recorded. In some embodiments, the information can be timestamped.

The enterprise digital assistant 104 can automatically verify whether the information was recorded accurately by comparing the earlier transmitted information with the actual information. In some examples, enterprise digital assistant performs the verification after a predetermined period of time, e.g., 300 ms, has elapsed. In other examples, a user can manually request that the enterprise digital assistant 104 perform the verification.

The user interface 340 further forwards and receives status, identifying and/or medical information to the network interface module 328 through a data transfer module 352. In some embodiments, the status information is, for example, information indicating the current status of the medical device or system 120. Accordingly, status information would include, for example, information indicating whether a vital signs monitor is configured to operate on pediatric patients or adult patients, or that a printer is out of paper or labels. In other embodiments, identifying information is, for example, information indicating the identity of a caregiver 108, a patient 112 and/or hospital staff 116. Accordingly, identifying information would include, for example, a patient's ID number, name, date of birth, and/or in some situations, a photograph of the patient 108.

In one embodiment, the application configuration module 320, based on a context determined by a workflow protocol, deems certain medical information as being too sensitive to be sent over a wireless network link. Accordingly, the application configuration module 320, configures the data transfer module 352 to select, for example, a wired network, to send the sensitive information.

In some embodiments, the network interface module 328 also reports the status of the network, i.e., whether the network connection is “up” or “down,” to the application configuration module 320. In response to detecting the absence of a network connection, the application configuration module 320 reconfigures the enterprise digital assistant 104 to change functionality to perform other tasks while waiting for restoration of network connection. Alternatively, the application configuration module 320 reconfigures the enterprise digital assistant 104 to detect another network connection.

### WAC Server Architecture:

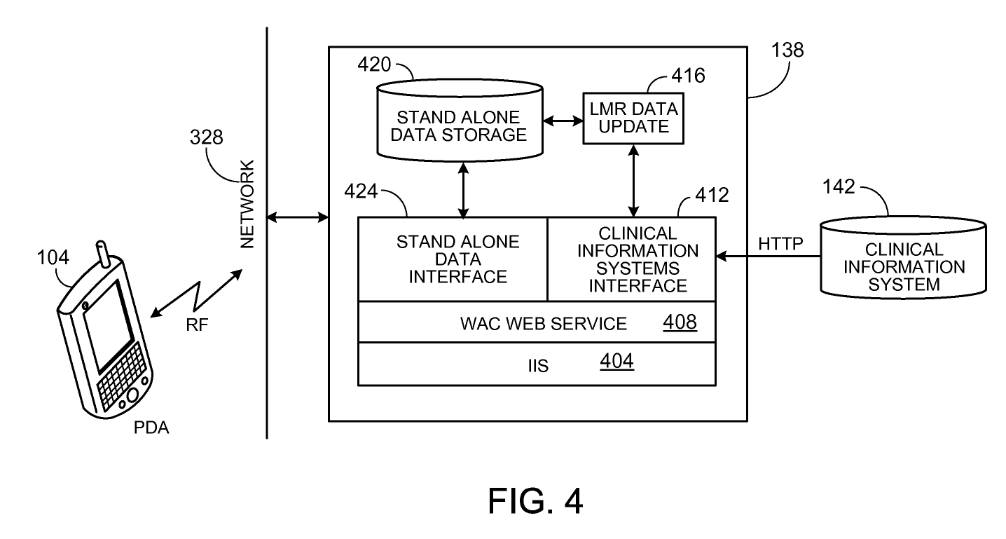

FIG. 4 is a schematic diagram of an exemplary WAC server architecture. As shown, the enterprise digital assistant 104 communicates over a network with the WAC server 138 through, for example, an RF connection. The WAC server includes an interface module 404, a WAC web service layer 408, a clinical information systems interface 412, an update server module 416, a stand-alone data storage 420 and a stand-alone data interface module 424.

The interface module 404 and the WAC web service layer 408 enable the enterprise digital assistant 104 to authenticate and communicate with the WAC server 138. In some examples, the interface module 404 is implemented in the WAC server 138 by, for example, the Internet Information Services (IIS) package from Microsoft Corporation.

The interface module 404 receives status, identifying and/or medical information from the enterprise digital assistant 104 over the network interface module 328. The interface module 404 then interfaces directly with the WAC web service layer 408 in order to manage the information. The WAC web service layer 408 allows the information received from the network interface module 328 to be easily validated, displayed, manipulated, stored and and/or retrieved through standard web calls, such as, for example, hypertext transfer protocol (HTTP) calls.

The WAC server 138 communicates with a clinical information system 142, through the clinical information systems interface 412. Accordingly, the WAC web service layer 408 transmits the medical information received from the enterprise digital assistant 104 to the clinical information systems interface 412, which in turn, transmits the information to the clinical informational system 142. The clinical information system 142 then updates data, such as, for example, medical records stored therein.

In the event the clinical information system 142 is down or the HTTP interface between the WAC server and the clinical information system 142 is not functional, the stand alone data interface 424 manages the medical information locally on the WAC server 138. During the down time of the clinical information system 142, the medical information is saved locally at the stand-alone data storage 420.

When the update server module 416 determines that the clinical information system 142 is accessible, medical information stored in the stand-alone data storage 420 is copied to the clinical information system 142. In some examples, the flow of medical information is bidirectional, i.e., the information flows both from the enterprise digital assistant 104 to the clinical information system 142 and from the clinical information system 142 to the enterprise digital assistant 104.

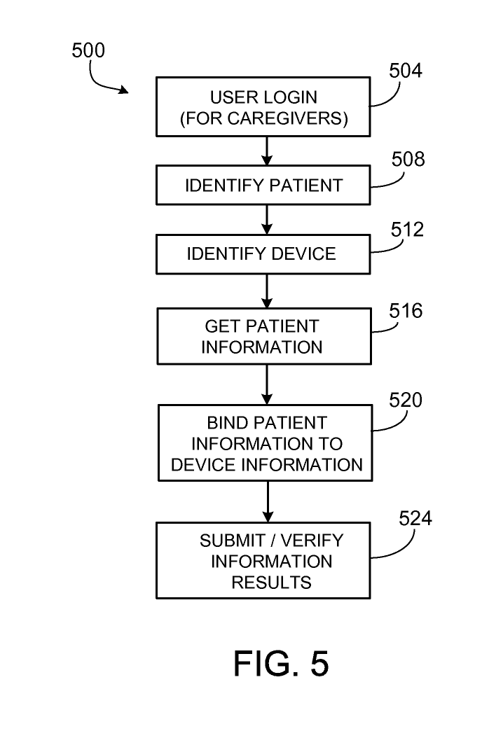

FIG. 5 is a flowchart illustrating an exemplary method 500 for automatically reconfiguring a context-sensitive enterprise digital assistant 104 operating within the WAC system 100. As shown, a user of the enterprise digital assistant 104 is prompted by the user interface 340 to login using a username/password combination (step 504).

In some examples, the caregiver 108 scans a barcode or RFID tag on an identification badge as part of the authentication process. In other examples, the enterprise digital assistant 104 is configured to incorporate other authentication and/or identification systems, such as, for example, a fingerprint reading system, a retina scanning system and/or a facial recognition system. In one embodiment, the user interface 340 also prompts the caregiver 108 to select a care group, e.g., “general care.”

The caregiver 108 then scans the wrist band of a patient 112 with the enterprise digital assistant 104 (step 508). As described above, in some examples, the enterprise digital assistant 104 can also use other authentication and/or identification systems to identify the patient 112. The application configuration module 320 automatically determines the context based on a workflow protocol from the workflow library 336, and reconfigures the enterprise digital assistant 104 to prepare for receiving/displaying contextually relevant medical information.

In some examples, the enterprise digital assistant 104 automatically downloads the patient's 112 medical information from an appropriate clinical information system 142. In other examples, the enterprise digital assistant 104 retrieves the relevant medical information from the stand alone data storage 420. The medical information is then displayed to the caregiver 108 by the user interface 340 for manual verification. The user interface 340 also provides the caregiver 108 “OK” or “Cancel” buttons to confirm or reject the information that is displayed.

The caregiver 108 scans a unique machine-readable identifier, e.g., a barcode, on a medical device or system 120 with the enterprise digital assistant 104 (step 512). Once again, the application configuration module 320 automatically determines the context based on another workflow protocol associated with the medical device or system 120 and reconfigures the enterprise digital assistant 104 to prepare for receiving/displaying the corresponding medical information.

In some embodiments, the enterprise digital information 104 establishes a communications channel, e.g., Bluetooth or infra-red (IR) connection, with the medical device or system 120 to retrieve patient information (step 516). In this manner, the data repository module 324 populates all relevant fields in the patient's 112 record based on identifying and medical information received from the user interface 340.

The enterprise digital assistant 104 then binds the medical information retrieved from the clinical information system 142 with the medical information received through the user interface and/or the communications channel from the medical device or system 120 (step 520).

Finally, the user interface 340 displays the information to the caregiver 108 for verification prior to submission to the clinical information system 142 (step 524). In some embodiments, the enterprise digital assistant 104 automatically executes a query subroutine to verify that the medical information is accurately written to the clinical information system 142. In one example of such a query subroutine, the data transfer module 352 and the verification module 348 automatically queries the WAC server 138 over the network interface module 328 to confirm the results.

### Examples

The following are merely illustrative examples of the apparatus, methods and computer program products disclosed herein and are not limiting. The specific features described below are merely used to illustrate and provide an overall understanding of the present invention. Accordingly, one skilled in the art will readily recognize that the present invention is not limited to any specific example described below.

In one illustrative example, the enterprise digital assistant 104 is used to automatically collect vital signs data. The principle medical entities involved are a caregiver 108, a patient 112 and a medical device 120, namely, a vital signs monitor 120-1 equipped with an IRDA connection.

In such a scenario, the caregiver 116 uses the vital signs monitor 120-1 to electronically take and store vital signs information from a patient 112 in an examination room. The caregiver 116 then uses the enterprise digital assistant 104 to scan a barcode on the vital signs monitor 120-1. The enterprise digital assistant 104 then communicates with the vital signs monitor 120-1 by establishing a specific, targeted communications connection, for example, an IRDA connection, or a Bluetooth connection. The caregiver 116 then scans a barcode on the patient 112. The vital signs information is then retrieved from the vital signs monitor 120-1 and associated with the patient 112 and flow into the enterprise digital assistant 104.

In some embodiments, the vital signs information also flow to an appropriate clinical information system 142 through the WAC server 138. In one example, each caregiver 116 in a health care ward is assigned an enterprise digital assistant 104. Accordingly, the enterprise digital assistant 104 is preprogrammed with the identity of the caregiver 116. Optionally, using the enterprise digital assistant 104 the caregiver scans a barcode on his own identification badge to confirm that he took the vital signs information for the patient 112.

In the foregoing example, all the medical data is captured electronically. As a result, no transcription is needed. Further, positive patient identification is assured. Moreover the enterprise digital assistant 104 does not assume the use of any specific medical device or system. Accordingly, changing vendors of medical device or system has no impact on any other medical device or system.

An advantage of the WAC system 100 arises from its ability to use relatively inexpensive communication solutions, e.g., IRDA, just as effectively as more expensive and complex communication solutions, e.g., WiFi. In this manner, various communications systems can be easily phased in without undue cost. Also, a medical device or system that is typically not network connected, e.g., a portable vital signs checker, is still able to upload medical data to an appropriate clinical information system 142 electronically.

This can be done because many such legacy devices feature a serial port that were originally intended for printer connection or to receive software updates. Such ports can be adapted to connect to dongles for providing short-range wireless communication with the enterprise digital assistant 104.

In another illustrative example, the enterprise digital assistant 104 is used to automatically capture the medical information of a patient 112 during a typical physical examination. The patient 112 is asked to stand on a weighing scale 136. The caregiver 116 then scans a barcode on the weighing scale 136. As a result, the enterprise digital assistant 104 automatically communicates with the weighing scale 136 and captures the weight of the patient 112.

Having established that the context is a physical examination, the enterprise digital assistant 104 automatically displays a keyboard on a display screen to prompt the caregiver 116 to enter the patient's 112 height. In this manner, the enterprise digital assistant 104 drives the workflow paradigm in a health care facility.

In yet another illustrative example, the enterprise digital assistant 104 automatically prints drug labels for anesthetics diluted or reconstituted in an operating room. The principle medical entities involved in this example are a medical system 120, e.g., an anesthesia “station” (further including a workstation running an anesthesia documentation system, a ventilator, a printer and a drug cart), a caregiver 108, a patient 112, and raw drugs, i.e., drugs directly supplied by a vendor that are not diluted or reconstituted.

In the foregoing example, the caregiver 116 uses the enterprise digital assistant 104 to scan a barcode on his or her identification card, thus confirming that he is authorized to proceed. In one embodiment, the caregiver 116 is prompted to enter a username/password combination to authenticate his credentials. The caregiver 116 then scans the patient's 112 wrist tag to instruct the enterprise digital assistant 104 to download relevant medical information from an appropriate clinical information system 142.

In some embodiments, the identity of the patient 112 is also established by identifying information contained in the anesthesia station. For example, the anesthesia station would already be set up with patient's 112 medical information and this information is automatically uploaded to the enterprise digital assistant 104 when then unique identifier on the anesthesia station is scanned.

In response to the scanning of the unique identifier on the anesthesia station, the enterprise digital assistant 104 automatically reconfigures itself to print labels for drugs. In some embodiments, the enterprise digital assistant 104 prints the drug labels using a built-in printer. In other examples, the enterprise digital assistant 104 wirelessly sends the information to a remote printer for printing the labels.

The caregiver 116 then scans the various raw drugs, thus prompting the enterprise digital assistant 104 to automatically generate a label based on the drugs and/or any other additional information, e.g., drug concentration and type, that the caregiver 116 enters, e.g., through a keyboard and the user interface 340. Since the enterprise digital assistant knows what anesthesia station the current operation is associated with, it can select an appropriate printer proximate to the anesthesia station to print the labels.

In some examples, the drug labels generated by the printer also include barcodes, i.e., “daughter” barcodes. Accordingly, when a daughter barcode is scanned, the enterprise digital assistant 10 automatically documents that the drug composition described by the label is administered to the patient 112 (determined by scanning the patient's 112 wrist tag).

### Implementation:

The techniques described herein can be implemented in digital electronic circuitry, or in computer hardware, firmware, software, or in combinations thereof. The techniques can be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer, or an enterprise digital assistant 104 having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

### Other Embodiments

Other embodiments are within the scope of the following claims. The techniques described herein can be performed in a different order and still achieve desirable results.

1. (canceled)

2. A method for automatically verifying information related to a medical entity with an enterprise digital assistant device operated by a user, the method comprising:
scanning a first unique machine-readable identifier associated with a first medical entity using an enterprise digital assistant device;
identifying, by one or more processing devices, the first medical entity based on the first unique identifier;
automatically configuring the enterprise digital assistant device based on the identity of the first medical entity to be in a first contextual mode to process information associated with the first medical entity;
parsing one or more data elements within the first unique identifier to determine relevant information, wherein said relevant information is relevant to the first contextual mode;
receiving from a clinical information system first medical information related to the identified first medical entity;
processing, by the one or more processing devices, both the relevant information, and the first medical information to generate processed data; and
automatically transmitting the processed data to one or both of the clinical information system and the enterprise digital assistant device.

3. The method of claim 2, wherein the relevant information comprises information for verifying a parameter related to the first medical entity and wherein processing comprises comparing a value of a parameter obtained from the information relevant to the first contextual mode with a value of the parameter obtained from the first medical information.

4. The method of claim 3, wherein processing further comprises detecting a discrepancy between an expected value of the parameter from the first medical information and an actual value of the parameter from the relevant information and generating an alert.

5. The method of claim 3, wherein the first medical entity is a medical device or a medical container and the parameter comprises critical medical information.

6. The method of claim 5, wherein the medical device is a syringe, infusion pump, drug label printer, or medical sensor or monitor.

7. The method of claim 5, wherein the medical container contains pills or tablets or other drug.

8. The method of claim 5, wherein the critical medical information comprises an expiration date, dosage information, drug concentration level, or expected bounds of a value of a parameter.

9. The method of claim 5, wherein the relevant information comprises any one or more of a drug name, a drug expiration date, and a drug concentration.

10. The method of claim 5, wherein processing further comprises detecting a discrepancy between an expected value of the critical medical information from the medical information and an actual value of the critical medical information from the relevant information and generating an alert.

11. The method of claim 3, wherein the first medical entity is a patient, the relevant information comprises identifying information of the patient, the clinical information system comprises an electronic medical record (EMR) system or longitudinal medical record (LMR) system, and the parameter comprises specific patient identifying information.

12. The method of claim 11, wherein processing further comprising detecting a discrepancy between the specific patient identifying information from the EMR or LMR and the specific patient identifying information from the relevant information and generating an alert.

13. The method of claim 11, wherein the enterprise digital assistant device uses the processed data to update an EMR or LMR

14. The method of claim 2, wherein the processed data comprises instructions for a medical actuator or for a user of the enterprise digital assistant device.

15. The method of claim 2, wherein the enterprise digital assistant device uses the processed data to track, review, and/or optimize the use of the first medical entity.

16. The method of claim 15, wherein the first medical entity is a medical device.

17. The method of claim 2, wherein the unique identifier is in the form of a bar code or an RFID tag.

18. The method of claim 2, further comprising:
scanning a second unique machine-readable identifier associated with a second medical entity;
identifying, by the one or more processing devices, the second medical entity based on the second unique identifier;
automatically reconfiguring the enterprise digital assistant device based on the identity of the second medical entity to be in a second contextual mode to process information associated with the second medical entity;
parsing one or more data elements within the second unique identifier to determine second relevant information within the second unique identifier, wherein the second relevant information is relevant to the second contextual mode; and
binding the second relevant information to the processed data from the first medical entity.

19. The method of claim 18, further comprising:
receiving from a clinical information system second medical information related to the identified second medical entity;
processing, by the one or more processing devices, the second relevant information and the second medical information to generate second processed data; and
automatically binding the second processed data to the processed data from the first medical entity.

20. The method of claim 18, further comprising:
receiving from a clinical information system second medical information related to the identified second medical entity;
processing, by the one or more processing devices, the second relevant information and the second medical information to generate second processed data; and
automatically transmitting the second processed data to one or both of the clinical information system and the enterprise digital assistant device.

21. The method of claim 18, wherein the first medical entity is a patient and the second medical entity is a medical device or medical container.

22. The method of claim 21, wherein the medical device is a syringe, infusion pump, drug label printer, medical sensor, or medical monitor.

23. The method of claim 21, wherein the medical container contains pills or tablets or other drug.

24. The method of claim 18, wherein the first medical entity is a patient and the second medical entity is a doctor or caregiver, and wherein the doctor or caregiver confirms the identity of the patient.

25. The method of claim 24, further comprising reading a unique identifier associated with a medical container and automatically confirming that contents of the medical container are to be administered to the identified patient.

26. The method of claim 25, further comprising confirming an expiration date of the contents of the medical container.

27. The method of claim 19, wherein the first medical entity is a medical device or medical container and the second medical entity is a doctor or caregiver.

28. The method of claim 19, further comprising automatically providing a series of prompts to the user through a user interface to alert the user to verify a portion of the second medical information.

29. The method of claim 18, wherein the relevant information and second relevant information each comprises information for verifying a parameter related to the first and second medical entities, respectively, and further comprising detecting for a discrepancy between an expected value of a parameter from the relevant information from the first medical entity and a value of the parameter from the second relevant information from the second medical entity and generating an alert in the event of a discrepancy.

30. The method of claim 28, wherein the alert is one of a visual alert and an audible alert.

31. The method of claim 2, further comprising prompting the user of the enterprise digital assistant device for authentication credentials.

32. The method of claim 2, wherein automatically configuring the enterprise digital assistant device to be in the first contextual mode comprises selecting a workflow protocol for the enterprise digital assistant.

33. The method of claim 32, wherein the workflow protocol is selected based on a type of interaction of the enterprise digital assistant device with the first medical entity.
